(19) United States
(12) Patent Application Publication
(10) Pub. No.: US 2006/0155783 A1
(43) Pub. Date: Jul. 13, 2006

(54) Historical information retrieval system

(76) Inventors: Martin E. DeWitt, Wyoming, MI (US); Harvey Dumond, Hudsonville, MI (US); Robert C. Bouws, Hudsonville, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/330,464

(22) Filed: Jan. 12, 2006

Related U.S. Application Data
(60) Provisional application No. 60/643,668, filed on Jan. 13, 2005.

(51) Int. Cl. G06F 17/30

(52) U.S. Cl. 707/203; 713/176; 710/104

(57) ABSTRACT

An embedded unit contains a microprocessor and memory for storing video, audio, photograph, and written digital data pertaining to a monument. The microprocessor, when actuated by a visitor, communicates through a two-way radio transceiver to a visitor carried transceiver. The embedded unit includes a long-life battery and is activated only upon a visitor approaching the marker and momentarily contacting an activation switch or passing an activating dongle adjacent the embedded unit for initiating power to the embedded unit for the transfer of data. A Bluetooth® receiver, such as a cellular phone having Bluetooth® capability, a PDA with Bluetooth®, or other Bluetooth® device, is employed for reading and/or storing information contained in the embedded unit.

### CROSS-REFERENCE TO RELATED APPLICATIONS

This application claims priority under 35 U.S.C. § 119(e) on U.S. Provisional Application No. 60/643,668 entitled MEMORIAL MEMORY MODULE, filed on Jan. 13, 2005, by Martin E. DeWitt, the entire disclosure of which is incorporated herein by reference.

### BACKGROUND OF THE INVENTION

The present invention relates to an electronic information retrieval system in which information in the form of data is stored and encapsulated within a permanent marker and can be accessed through an electromagnetic link by a visitor.

There have been proposed numerous methods of accessing information stored in monuments, such as historical monuments, grave stones, and other fixed locations where historical events have taken place or where a family member has been interned. Such systems frequently employ a physical electrical connection between a storage device contained within the monument and which receives power from a reading device. In some cases, the systems are self-powered either by battery or solar-powered cells. Recent suggestions have employed the use of direct contact devices, such as an I-Button®. Such systems, however, suffer the limitations that they either require specialized reading devices, which are not commonly available, or require multiple interconnected components which are prone to failure with time and weather conditions in the outdoor environment.

Thus, there remains a need for a system by which a visitor to a historical monument, grave site, or other location which may be of interest may retrieve information, such as video, audio, photographic, or written information relating to the site being visited.

### SUMMARY OF THE INVENTION

The system of the present invention accomplishes this goal by providing a unique embedded module which contains a microprocessor and digital memory storage for storing video, audio, photographic, and written data pertaining to a person, place, or event. The microprocessor, in turn, communicates through a two-way radio transceiver, such as employing Bluetooth® technology, to a visitor to the area. The embedded unit is hermetically sealed and encased and sealed within a permanent marker against environmental conditions. The embedded unit includes a long-life battery and is activated only upon a visitor approaching the marker and momentarily contacting an activation switch or, in one embodiment, passing an activating card adjacent the embedded unit for initiating power to the embedded unit for the transfer of data. A Bluetooth® receiver, such as a cellular phone having Bluetooth® capability, a PDA with Bluetooth®, or other Bluetooth® or RF device, is then employed for downloading and storing the information contained in the embedded unit. In one embodiment, an intermediate device is employed to activate and retrieve information from the embedded unit and subsequently rebroadcasts the information to the visitor's receiver.

With such a system, a robust long-life embedded memory module is provided for storing data which can be easily accessed by a visitor utilizing commonly available cell phones and PDA's with Bluetooth® capabilities. The cost of such a unit is greatly reduced in view of the use of inexpensive, mass produced, electrical components and the visitor can use their existing Bluetooth® cell phones or PDA's.

These and other features, objects and advantages of the present invention will become apparent upon reading the following description thereof together with reference to the accompanying drawings.

### BRIEF DESCRIPTION OF THE DRAWINGS

FIG. 1 is a schematic diagram of the system of gathering information, which is embedded into a memorial which can subsequently be read by a visitor with a Bluetooth® technology device;

FIG. 2 is a block electrical circuit diagram of the embedded unit shown in FIG. 1;

FIG. 3 is a front elevational view of the exposed face of an embedded unit;

FIG. 4 is a fragmentary perspective view of a monument in which an embedded unit has been installed;

FIG. 5 is a schematic view of an alternative embodiment of the invention showing an intermediate activating and reading device carried by a visitor also using a Bluetooth® receiver as in the first embodiment;

FIG. 6 is an enlarged front elevational view of an intermediate activating device employed with the second embodiment;

FIG. 7 is an electrical circuit diagram in block form of the embedded unit of the FIG. 5 embodiment; and

FIG. 8 is an electrical circuit diagram in block form of the activating unit shown in FIG. 6.

### DETAILED DESCRIPTION OF THE PREFERRED EMBODIMENT

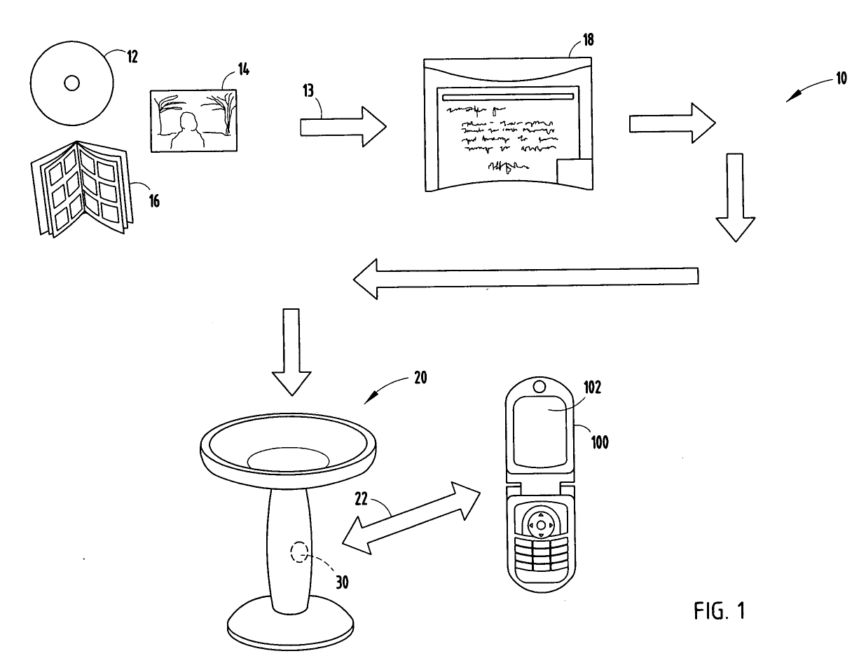

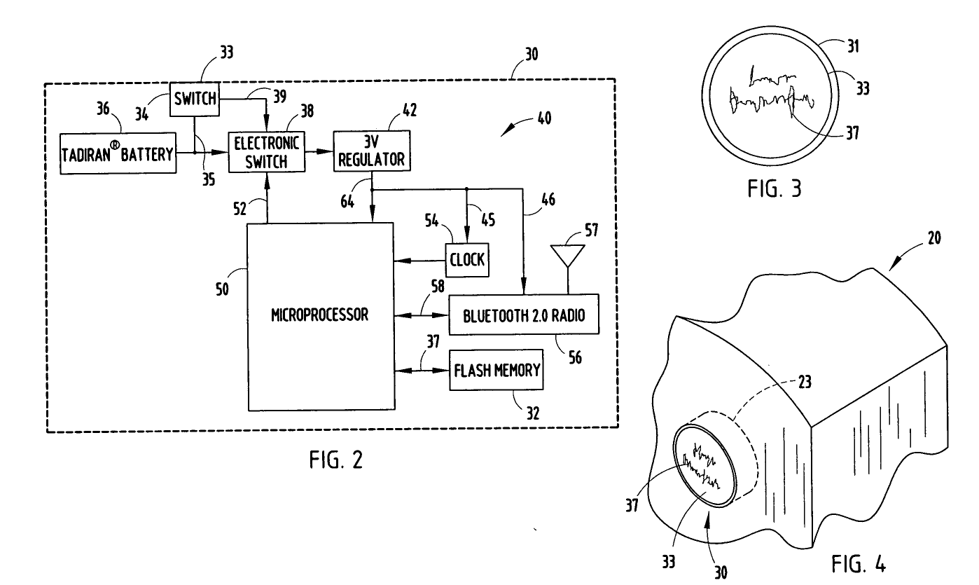

Referring initially to FIG. 1, there is shown a flow diagram of the compilation of information which can be embedded into a monument 20 within an embedded unit 30 of the present invention. Monument 20 can be any form of monument, such as an urn, grave stone, historical marker, or the like, typically made of a durable material, such as granite or the like. The embedded unit 30 is sealed within the monument but typically has either an exposed surface or an identification area indicating that the monument contains such an embedded electronic circuit. The system 10 of the present invention includes the process of gathering information to be digitally stored in embedded unit 30. Such information may include, for example, video or audio recordings on a disk 12, such as a DVD or CD, photographs 14, or photographs and written commentary 16 as to a person's life, history, or historical events which have taken place at the site of the monument 20. If monument 20 is a grave marker, the embedded unit will typically include the life history of the interned person and may include video footage of events in the person's life featuring his or her self, as well as audio recordings of the person's voice, family gatherings, or the like. Further information may include photographs, such as depicted by representation 14, and/or photographs and written descriptions of events during a person's life as may be recorded in a diary or album 16. This information is gathered, as indicated by arrow 13, and assembled, typically by a service organization, and converted into a readable digital format, as represented by block 18, utilizing standard scanning and recording techniques, such as converting video to Mpeg compressed video, photographs into JPG compressed photographs, and written description into PDF files or any combination of generally available digital recording formats. The information is then burned onto a flash memory 32, shown in the block diagram of embedded unit 30 of FIG. 2, for use by the embedded unit and accessed by a visitor.

Converting of information 12, 14, and 16 into a digital format which is usable and stored in flash memory can be provided by a service company or family members with the capability of converting such information into digital data. The company manufacturing the embedded device 30 may also provide the service to family members or organizations desiring to place an embedded memory module in a monument. Typically, the flash memory will be in the form of a programmable read-only memory with a capacity of anywhere from 128 megabytes to several gigabytes as required by the amount of information to be stored. Such memories are readily available from numerous commercial sources.

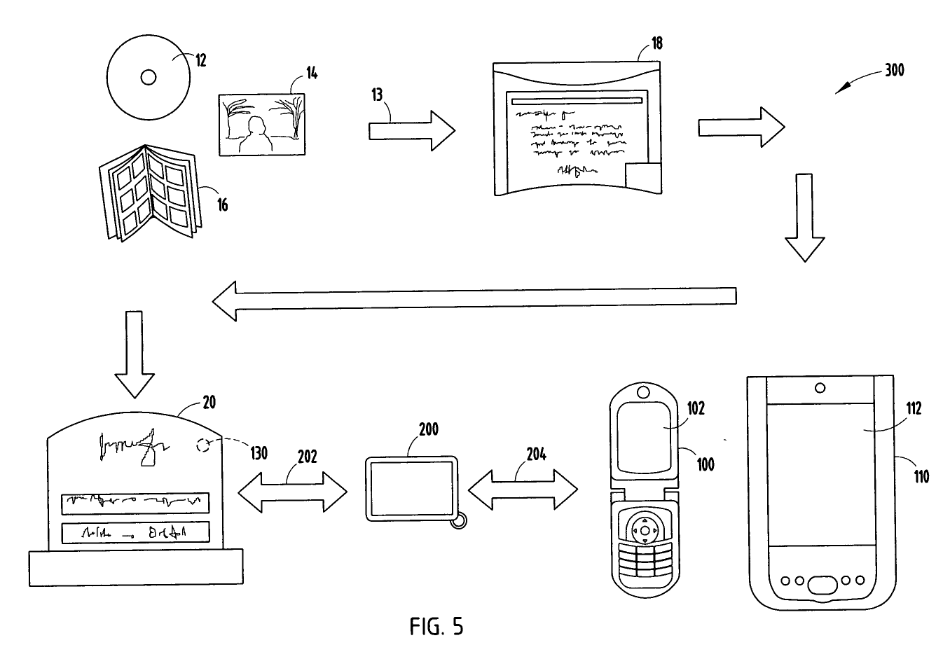

The embedded unit 30 communicates, as illustrated in FIG. 1, by a two-way RF link represented by arrow 22. In a preferred embodiment, the 2.4 gigahertz unlicensed ISM band popularly referred to as Bluetooth® RF is employed to enable the visitor carried reading device, such as a Bluetooth® cell phone 100 or, as illustrated in an alternative embodiment of FIG. 5, a Bluetooth® capable PDA 110 to access the stored information. Both of these devices are capable of receiving and storing the information stored on flash memory by the communications between the reading device 100/110 and the embedded module, either directly (as shown in FIG. 2) or through an intermediate device (as shown in the embodiment of FIG. 5).

The circuit details of an embedded device of a first embodiment of this invention is shown in FIG. 2. The embedded device 30 itself is shown in FIGS. 3 and 4 and comprises a cylindrical housing 31. which has a diameter of approximately 2.5 inches and a depth of approximately 0.5 inch. The unit is a hermetically sealed enclosure which encloses, as seen in FIG. 2, the electronic circuits contained therein. The front surface 33 of the embedded unit comprises a contact area for a switch 34 which activates the system upon touching by a visitor. Switch 34 may be a momentary push-button mechanical switch or a capacitive switch, which detects a capacitive change upon touching by a visitor standing at the monument. Typically, the surface 33 of the embedded unit 30 will be exposed, as shown in FIG. 4, such that a visitor can see that the monument 20 includes an embedded unit with electronically stored data regarding the information relating to the monument. Surface 33 may include printed indicia 37, such as instructions for operation, information about the monument, or a graphic design. The embedded unit will typically comprise a two-piece cylindrical housing made of a durable RF transparent material, which includes the circuitry of FIG. 2 and which is subsequently hermetically sealed upon insertion of the electrical components. It may employ stainless steel as part of the housing, which could also serve as one of the antennas. Alternatively, the electrical components could be encased in a molded polymeric plug having the shape of the embedded unit 30. The physical housing 31 is subsequently inserted into a cylindrical aperture 23 drilled or otherwise formed in the monument 20 and sealed therein by suitable sealing composition, such as epoxy or silicone based adhesive seal.

The electrical circuit 40, as shown in FIG. 2, which is contained within the embedded unit 30 includes, as noted above, a switch 34 which is positioned with the unit such that, upon touching the face or surface 33 of the embedded unit 30, switch 34 is activated from an open state to a momentarily closed state. Switch 34 is coupled to a long-life battery 36, such as a Tadiran® battery Model No. TL-2100 which has an expected life of at least 20 years and frequently longer, depending upon the amount of use it receives. Switch 34 can be a momentary spring-loaded pushbutton switch which can be activated upon a sealed flexible membrane forming face 33 of embedded unit 30 or a capacitive switch which detects the touching of surface 33, in which case surface 33 would form one plate of the capacitive switch 34. Battery 36 is coupled to switch 34 by conductor 35 and to an electronic switch 38 which is latched on upon the momentary application of power to switch 38 from switch 34 by conductor 39. Switch 38, once latched on, remains on until a microprocessor 50 within circuit 40 applies an off signal to switch 38 via conductor 52 to deactivate power from battery 36 to the electrical circuit 40. While switch 38 is latched on, however, it applies power to a three-volt regulator 42 which, in turn, supplies operating power to microprocessor 50 through conductor 44 to a clock circuit 54 via conductor 45 and to a Bluetooth® transceiver 56 coupled by conductor 46. The regulator 42 is of conventional design and the flash memory 32 is a commercially available Model No. ST MT28F128 memory having a parallel connection 37 to microprocessor 50. The clock typically will be a 40 MHz clock which provides timing signals to the microprocessor for operation of the system. The microprocessor includes a UART communication link 58 to the Bluetooth® transceiver 56 which includes an antenna 57 for communicating with the Bluetooth® receiving device 100 or 110. The microprocessor, in one embodiment, was a PIC18F8527 while the Bluetooth® radio 56 was a commercially available eb100-SER operating, as noted above, in the 2.4 gigahertz frequency range.

The Bluetooth® transceiver 56 has a useful range of about 30 feet, such that the visitor can stand a reasonable distance from the monument 20 once the embedded unit is activated. Once powered, the Bluetooth® receiver 100/110 will communicate with the transceiver 56 in a handshake operational mode, which is conventional, and the microprocessor 50 may be programmed to provide a sequence of operational instructions transmitted to the visitor, such as a menu of the type of information, such as video, audio, or written, which the visitor wishes to review and/or download. The visitor operating receiving device 100/110 may elect to store or simply review the data stored in flash memory 32 live through the display 102 or 112 on the Bluetooth® receiver 100/110, respectively. This information, as noted above, may include video footage in the form of streaming Mpeg video, JPG still images or other compressed format images, PDF files, or other readable data relating to the person, place, or event for which the monument has been placed.

Upon completion of the transmission of information from the Bluetooth® radio 56 through Ethernet connection 58, the microprocessor 50 will await a predetermined period of time, such as five minutes or the like, to await further communications from the reading device 100/110 and, if none are received, will provide a signal through line 52 to the electronic switch 38 which disconnects battery 36 for preserving power for subsequent use.

With the system of FIG. 1, any individual can access any monument 20 to obtain information therefrom through the RF interconnection link between the embedded unit 30 and the reading device 100/110 or future reading devices which may also operate utilizing electromagnetic energy. When restricted access to information contained within an embedded unit 30 is desired, the alternative embodiment shown in FIGS. 5-8 provides a system in which an additional activating element is employed for transferring information from the embedded unit to the Bluetooth® reading device.

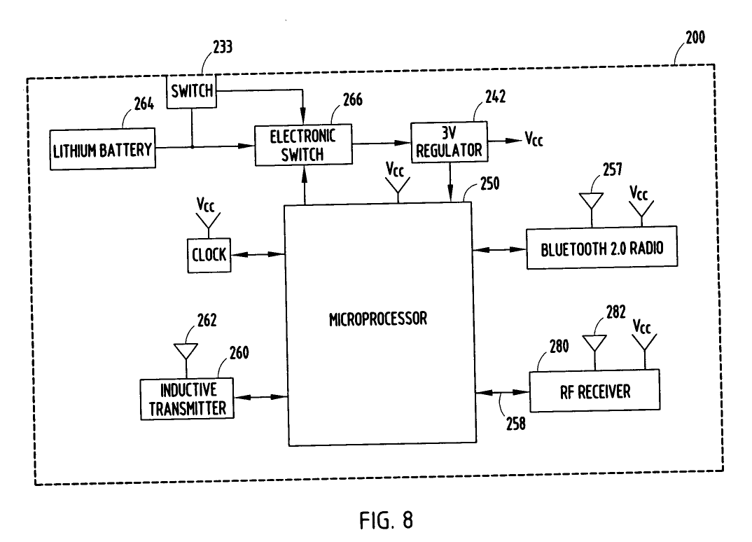

FIG. 5 illustrates the second embodiment of the invention which shares in common with the first embodiment, the collection of video information, such as on a CD or DVD 12; photographic information, such as through photographs or slides 14; and/or written information, such as by diaries or photo album 16; which are transmitted to a service provider 18 for converting the information into digital data which is also embedded in a flash memory, such as memory 132, in the embedded unit 130, shown in FIG. 7. Embedded unit 130 has the same physical configuration as embedded unit 30 but has additional electrical components as described below in connection with FIG. 7. As with the first embodiment, the embedded unit 130 is sealably positioned within a monument 20 and communicates, as illustrated in FIG. 5, through an intermediate device 200, typically referred to as a dongle or fob, the circuit for which is shown in FIG. 8. The dongle 200, in turn, communicates with embedded unit 130 through RF link 202, which receives the data contained in the embedded unit 130 and subsequently retransmits it through RF link 204 to reading device 100 or 110.

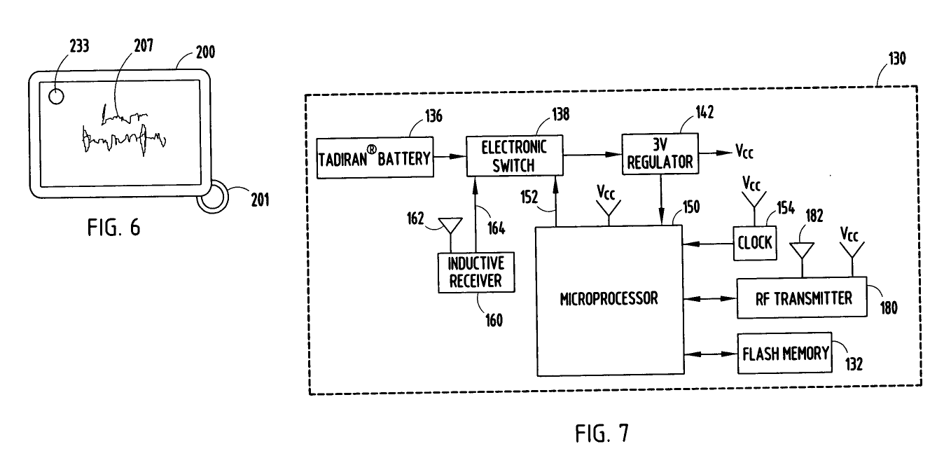

The dongle 200, as seen in FIG. 6, is a fob-like device having a relatively small size, such as 1×1.5 inches rectangular and 0.25 inch thick, and may include a key ring 201 for attaching the fob to a suitable carrier for a visitor. Dongle 200 functions to communicate through a two-way RF link 202 with embedded unit 130 as well as activating the embedded unit 130 through the additional circuitry now described in connection with FIGS. 7 and 8. The circuit and components similar to those of the FIG. 2 embodiment are identified by the same reference numerals proceeded by a “1”.

Embedded unit 130 operates in a similar matter to embedded unit 30 in terms of its communication with the flash memory 132 and use of the clocked microprocessor 150, however, in place of a touch-actuated electrical switch 34, an inductive receiver 160 comprising a loop antenna 162 and demodulator contained within receiver 160 receives a signal from an inductive transmitter 260 contained within the dongle 200 and also including an antenna 262 when actuated by the visitor manually activating a switch 233 on the dongle 200. Activation of switch 233 couples a lithium battery 262 output to an electronic switch 266 which latches on for applying power through a three-volt regulator 242. The output voltage VCC from regulator 242 is applied to the various components of the dongle circuit, as shown in FIG. 8. The inductive transmitter receives a pulse or pulses from microprocessor 250 upon actuation of switch 233, which activates transmitter 260 to provide an RF signal which is detected by inductive receiver 160 through an inductive link. The link is achieved by the visitor holding the dongle from 1 to 2 inches from the embedded unit 130, which is visibly mounted within the monument, as illustrated in the first embodiment in FIG. 4. This voltage pulse output on conductor 164 from inductive receiver 160 actuates the electronic switch 138 to power up the microprocessor 150 through regulator 142 as well as the clock 154 and an RF transmitter 180 coupled to an antenna 182 for providing an RF link 202 between the embedded unit 130 and dongle 200. The dongle 200 likewise includes an RF receiver 280 coupled to an antenna 282, with both transmitter 180 and receiver 280 being FM modulated and operating at the same frequency in the publicly available 300 to 400 MHz range or, alternatively, the 900 MHz range. Receiver 280 is coupled to the microprocessor 250 through a suitable communication link 258. Once dongle 200 is activated and activates unit 130 when within a range of up to about 10 to 15 feet from the monument 20, it will transfer the data from the monument unit 130 through transmitter 180 to receiver 280. The received data is stored within the microprocessor 252 until such time as the visitor actuates the Bluetooth® reading device 100/110. Dongle 200 also includes a Bluetooth® transceiver, such as 256 of the same type as disclosed in the first embodiment, and having an antenna 257 for communicating in the 2.8 gigahertz range with the reading device 100/110 also carried by the visitor. Microprocessor 150 in the embedded unit 130 will timeout after the transmission of information from transmitter 180 to receiver 280 to send a control signal via conductor 152 to electronic switch 138 for decoupling the Tadiran® battery 136 from the system, thereby saving power for the battery associated with the embedded unit 130.

The system 300 of FIG. 5 may include the provision of several dongles 200 used, for example, by various members of a family who wish to visit a family member's grave site. Each dongle 200 may have suitable indicia 207 (FIG. 6) thereon for identifying the owner of the dangle or its use with a particular monument. Additionally, in a national park or museum facility or the like, the facility operator may rent or loan dongles to visitors for their use in connection with their Bluetooth® receiving devices 100 or 110 to displays or historical monuments for obtaining the information therefrom which is in the embedded units 130 associated therewith. Thus, the system shown in FIGS. 5-8 provide a second level of communication which requires the use of an intermediate retransmission device, such as dongle 200, which allows a greater degree of security for access to the information contained within an embedded unit 130. If desired, the microprocessors 150 and 250 may include security codes associated with the dongle 200 and embedded device 130 such that only certain dongles will work with certain embedded devices upon the establishment of a communication link 202 therebetween. As in the first embodiment, link 204 is typically available for a distance of up to about 30 feet using standard Bluetooth® technology.

Although the preferred embodiment of the present invention employs RF frequency electromagnetic radiation as the communication link between the embedded units and the receiver or through the intermediary retransmitting device, it is understood that other electromagnetic energy at other frequencies likewise could be employed should receiving devices subsequently become universally available and popular in the future. It will become apparent to those skilled in the art that these and other modifications to the preferred embodiments of the invention as described herein can be made without departing from the spirit or scope of the invention as defined by the appended claims.

The invention claimed is:

1. A sealed storage unit for digital data, such storage unit adapted to be embedded within a monument, and comprising:
a hermetically sealed housing; and
an electrical circuit sealed within said housing and including a memory containing data relative to the monument into which said storage unit is mounted, a microprocessor coupled to said memory, a battery power source, a switch positioned in said housing to be actuated by a visitor to the monument, said switch coupled to said battery and to said microprocessor for providing electrical operating power thereto, and an RF transceiver coupled to said microprocessor for communicating with a handheld RF receiver carried by a visitor which, upon actuation of the electrical switch in said housing, transmits data from said memory to the visitor's handheld RF device.

2. The storage unit as defined in claim 1 wherein said memory is a flash memory.

3. The storage unit as defined in claim 1 wherein said switch is a pushbutton switch.

4. The storage unit as defined in claim 1 wherein said switch is a capacitive switch.

5. The storage unit as defined in claim 1 wherein said electrical circuit further includes a second switch coupled to said switch, to said battery, and to said microprocessor for latching to an on state for powering said electrical circuit for a predetermined time.

6. The storage unit as defined in claim 1 wherein said RF transceiver comprises a Bluetooth® transceiver.

7. The storage unit as defined in claim 6 wherein a visitor's handheld device comprises one of a Bluetooth® cell phone or Bluetooth® PDA.

8. A system for storing data within a monument for access by a visitor through a radio frequency (RF) transmission link comprising:
an embedded unit including a microprocessor and a memory coupled to said microprocessor for the storage of information relating to the monument, a battery power source, an inductive receiver for receiving inductively transmitted signals from a hand-carried dongle, an electronic switch coupled to said inductive receiver and to said battery for coupling said battery to said microprocessor for providing operating power thereto, and an RF transmitter coupled to said microprocessor for transmitting data contained in said memory to a dongle; and
a dongle which includes a power source, an actuating switch for coupling said power source to a microprocessor, said microprocessor coupled to an inductive transmitter which, when positioned adjacent said embedded unit in a monument, provides an activation signal received by said inductive receiver to activate said embedded unit, said dongle further including an RF receiver tuned to the frequency of said RF transmitter of said embedded unit for transmitting stored data from said embedded unit to said dongle microprocessor, and an RF transceiver coupled to said microprocessor for retransmitting data received from said RF receiver and said dongle to a visitor transceiver.

9. The system as defined in claim 8 wherein said RF transceiver uses Bluetooth® technology.

10. The system as defined in claim 9 and further including a visitor carried transceiver which is one of a Bluetooth® cell phone or Bluetooth® PDA.

11. A system for transmitting data relating to a monument to a visitor to said monument, said system comprising:
a readable memory for storing one or more of video, audio, photographic, or text data;
a hermetically sealed container for encasing said readable memory within a monument, said sealed container including a Bluetooth® transceiver and a circuit for transferring said data to said Bluetooth® transceiver; and
a visitor carried Bluetooth® transceiver for reading said data in said readable memory.

12. The system as defined in claim 11 wherein said sealed container includes a memory containing data relative to the monument into which said container is mounted, a microprocessor coupled to said memory, a battery power source, a switch positioned in said container and accessible for actuation by a visitor to the monument, said switch coupled to said battery and to said microprocessor for providing electrical operating power thereto for a predetermined period of time.

13. The system as defined in claim 12 wherein said memory is a flash memory.

14. The storage unit as defined in claim 13 wherein said switch is a pushbutton switch.

15. The storage unit as defined in claim 13 wherein said switch is a capacitive switch.

16. The system as defined in claim 11 wherein said sealed container includes:
a microprocessor;
a memory for information relating to the monument coupled to said microprocessor;
a battery power source;
an inductive receiver for receiving inductively transmitted signals from a hand-carried dongle;
an electronic switch coupled to said inductive receiver for coupling said battery to said microprocessor for providing operating power thereto; and
an RF transmitter coupled to said microprocessor for transmitting data contained in said memory to a dongle;
a dongle having a power source and an actuating switch for coupling said power source to a microprocessor, a microprocessor coupled to an inductive transmitter which, when positioned adjacent the sealed container in said monument, provides an activation signal for said inductive receiver to activate said switch for providing power to said embedded unit, said dongle further including an RF receiver tuned to the frequency of said RF transmitter of said sealed container for receiving stored data from said RF transmitter; and
a Bluetooth® transceiver coupled to said microprocessor for retransmitting data received from said RF transmitter to said visitor carried Bluetooth® receiver.

17. The system as defined in claim 16 wherein said memory is a flash memory.

18. A method of providing information to a visitor relating to a monument comprising:
collecting data relative to a monument;
digitizing said data;
storing the digitized data in a battery-actuated embedded storage unit which can be momentarily actuated by a visitor; and
transmitting the data from said storage unit through a Bluetooth® transceiver upon actuation of said embedded unit to a visitor carrying a Bluetooth® transceiver.

19. The method as defined in claim 18 and further including:
carrying a dongle which, when placed in proximity of the embedded storage unit, activates power to the embedded storage unit and which receives data therefrom; and
retransmitting information received by said dongle through a Bluetooth® RF link to the visitor carried Bluetooth® receiver.

20. The method as defined in claim 19 and further including encoding the transmitting step to allow access to said digitized data only by users having a predetermined code.
